(19) United States
(12) Patent Application Publication
(10) Pub. No.: US 2015/0183097 A1
(43) Pub. Date: Jul. 2, 2015

(54) FLEXIBLE WRENCH

(71) Applicant: Jusuf REIZ, Örebro (SE)

(72) Inventor: Jusuf Reiz, Orebro (SE)

(73) Assignees: Ismet Reiz, Orebro (SE); Nisvet Reiz, Orebro (SE)

(21) Appl. No.: 14/416,885

(22) PCT Filed: Jul. 19, 2013
(86) PCT No.: PCT/SE2013/000117

§ 371 Date: Jan. 23, 2015

(30) Foreign Application Priority Data
Jul. 24, 2012 (SE) 1200457-8

(51) Int. Cl. B25B 23/00; B25B 13/48; B25B 13/46

(52) U.S. Cl. CPC B25B 23/0028; B25B 13/46; B25B 13/481

(57) ABSTRACT

A wrench for tightening and loosening a fastener in confined spaces. The wrench includes a wrench head, an intermediate part and an extension handle. The intermediate part includes a cylindrical part, having a circular or oval cross section, rotatably arranged on the extension handle by way of an adjustable spindle. The wrench head is detachably arranged on the intermediate part of the wrench by way of a simple turning and locking mechanism.

### TECHNICAL FIELD

The present invention relates to a flexible wrench, for turning fasteners such as screws, bolts and nuts, for example, in confined spaces. The wrench may also relate to a torque wrench, a ratchet spanner or a combination spanner.

### BACKGROUND OF THE INVENTION AND PRIOR ART

The use of wrenches for turning screws and nuts in confined spaces, such as engine compartments, for example, involves difficulties in getting at and turning a fastener, which makes the work complicated and time-consuming. To facilitate the work, wrenches have been developed having an extended handle rotatably arranged on the head of the wrench. The patent document US 2007/0074607 A1 shows a wrench of said type having an extended handle rotatably arranged on the head of the wrench, the wrench also comprising an adjustable ratchet function between the handle and the head of the wrench. The patent document U.S. Pat. No. 6,382,058 B1 furthermore discloses a wrench or ratchet spanner having a rotatable handle in which the handle is detachably fitted by means of screws or rivets.

One problem with the aforementioned wrenches lies in the difficulties that occur when the wrench needs to be adapted to different types of working spaces and/or to different types of fastener to be turned. A further problem lies in the complex construction of the wrenches with many parts, which makes said wrenches unwieldy and expensive to produce.

### AIM AND CHARACTERISTIC FEATURES OF THE INVENTION

A main object of the present invention is an improved wrench which can be adapted rapidly and easily for work in different types of spaces and which can easily be adapted to different types of fastener to be turned.

A further object of the invention is a flexible wrench having few constituent parts, which is both robust and easy and inexpensive to produce.

Said objects and other aims not set forth here are satisfactorily achieved through the specifications in the present independent patent claim.

Embodiments of the invention are specified in the dependent patent claims.

According to the present invention, therefore, an improved wrench has been created for turning fasteners such as screws, bolts and nuts in confined spaces, comprising a wrench head, an intermediate part and an extension handle, the intermediate part comprising a cylindrical part having a circular or oval cross section, rotatably arranged on the extension shaft by way of a transverse joint.

The wrench is characterized in that the wrench head is detachably arranged on the intermediate part of the wrench by way of a turning and locking mechanism.

According to further aspects of the wrench:

the turning head comprises a tapering part having a circular or oval cross section designed to fit in the cylindrical part of the intermediate part,

the turning and locking mechanism comprises: a sprung detent ball bearing arranged on the tapering part of the wrench head, a hole corresponding to the detent ball bearing and arranged in the tubular part of the intermediate part for locking the detent ball bearing, a guide groove on the inside of the intermediate part for guiding the detent ball bearing whilst turning the wrench head from the open to the locked position, in which the length of the guide groove corresponds to a turning of the wrench head by one quarter turn and in which the pitch of the guide groove corresponds to a tightening of the wrench head in an axial direction by 1-5 mm,

the turning and locking mechanism also comprises a guide pin of square cross section fixedly arranged on the tapering part opposite the detent ball bearing; a second guide groove of square cross section on the inside of the intermediate part opposite the first guide groove, for more precise guiding of the guide pin when turning the wrench head from the unlocked to the locked position,

the wrench head comprises an adjustable ratchet mechanism, which is adjustable for clockwise or anticlockwise turning of the fastener,

the upper part of the wrench head, comprising the ratchet mechanism, is detachably arranged on the wrench head by way of a mechanical coupling,

the mechanical coupling comprises a turning spindle for turning the upper part in a vertical direction relative to the upper part of the wrench head and relative to the fastener.

### ADVANTAGES AND EFFECTS OF THE INVENTION

The invention affords a series of advantages and effects, the most important of which are as follows:

The simple and robust construction of the turning and locking mechanism allows rapid and easy changing of the wrench head for different types of fastener.

The turning function of the extension handle allows turning of a fastener up to 240° in confined spaces.

The variable length of the extension handle afforded by a lockable telescopic mechanism allows efficient working in various types of spaces.

The simple construction of the wrench affords a design that is easy and inexpensive to produce.

The invention has been defined in the following patent claims and will now be described in somewhat more detail in conjunction with the figures attached.

Further advantages and effects will be apparent from a study and consideration of the following detailed description of the invention, whilst referring to the figures of the drawing attached, in which:

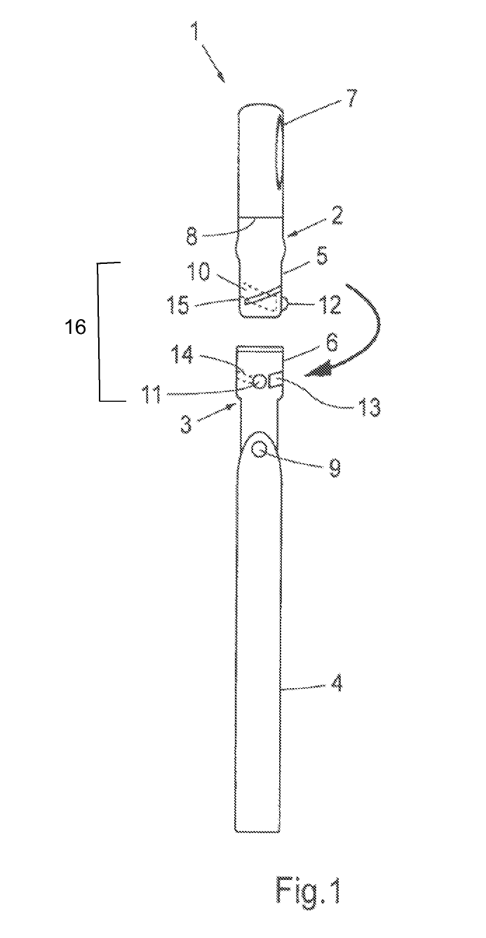

FIG. 1 schematically shows a wrench having an articulated extension handle and a wrench head that can be fitted by way of a turning and locking mechanism.

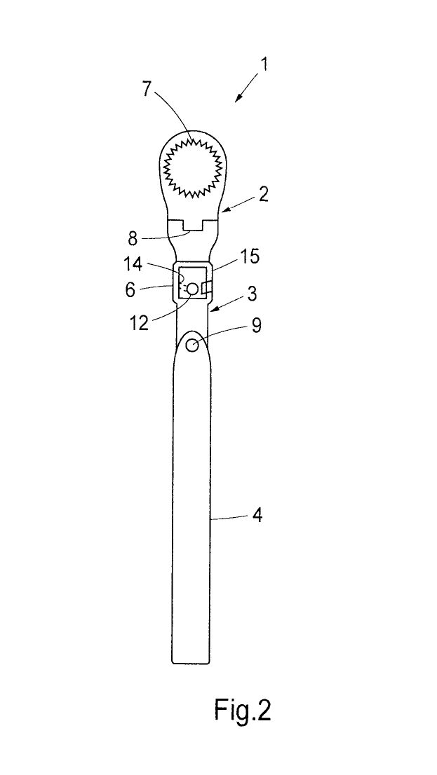

FIG. 2 shows the wrench according to FIG. 1 with the wrench head fitted.

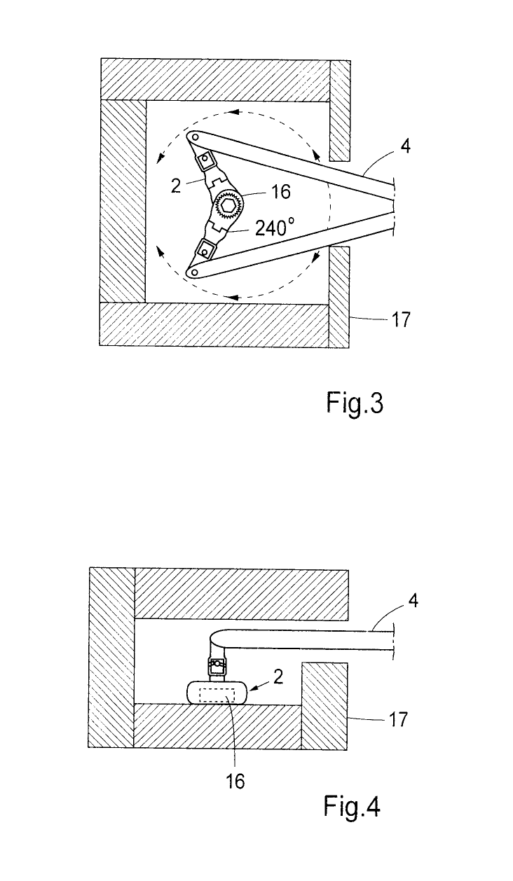

FIG. 3 shows the working, viewed from above, of a wrench according to FIG. 1, in a confined space with no depth.

FIG. 4 shows the working, viewed from the side, of a wrench according to FIG. 1, in a confined space with depth.

### DETAILED DESCRIPTION OF EMBODIMENTS

A preferred embodiment of the wrench 1 and its working according to the invention are shown in FIGS. 1, 2, 3 and 4. The wrench 1, according to 1 and 2, comprises three main parts: a wrench head 2, an intermediate part and an extension handle 4, the extension handle 4 being rotatably arranged on the intermediate part 3 of the wrench 1 by way of a turning spindle 9. The turning function of the extension handle 4 allows turning/rotation of a fastener of up to 240° in a confined space, as is shown in FIG. 3. The intermediate part 3 comprises a tubular or cylindrical part 6, preferably of circular cross section. Embodiments of different cross section may also be used.

In one embodiment, the turning spindle 9 is designed with a manually adjustable locking arrangement for locking the extension handle 4 in specific positions/angles. In yet another embodiment of the extension handle, the extension handle 4 is designed with a variably lockable telescopic mechanism (not shown), which means that the length of the handle 4 can be continuously varied and locked at specific lengths, so that it can thereby be adjusted to the depth of a confined space 17.

The wrench head 2 is designed with a tapering part 5, preferably of circular cross section, in order to fit in the cylindrical part 6 of the intermediate part 3.

The wrench head 2 is detachable and is arranged on the intermediate part 3 by way of a turning and locking mechanism. The turning and locking mechanism comprises a sprung detent ball bearing 12 arranged on the tapering part 5 of the wrench head 2. The detent ball bearing 12 is preferably sprung by means of a coil spring. A hole 11 for locking the detent ball bearing 12 is arranged on the tubular or cylindrical part 6 of the intermediate part 3. A guide groove 13, preferably of circular cross section, for guiding the detent ball bearing 12 to the locked position in the hole 11 when fitting the wrench head 2, is arranged on the inside of the tubular part 6 of the intermediate part 3.

The length of the guide groove 13 corresponds to a turning of the wrench head 2 by one quarter turn. The guide groove 13 has a pitch, from the locked to the unlocked position, in the interval 10°-60°, which corresponds to an axial tightening of the wrench head 2 of between 1-5 mm.

The design of the turning and locking mechanism therefore means that the wrench head 2 can be fitted and detached only in one and the same way, which effectively prevents incorrect working.

The wrench head 2 is fitted by pressing the tapering part 5 of the wrench head 2 down into the cylindrical part 6 of the intermediate part 3, following which the wrench head 2 is turned one quarter turn clockwise until the detent ball bearing 12 clicks firmly into the hole 11, the turning movement being guided by the guide groove 13. The head is detached by pressing the guide ball against the tapering part 5, before turning the wrench head 2 one quarter turn anticlockwise.

In order to further improve the fitting and locking function, the turning and locking mechanism also comprises a guide pin 15, preferably of square cross section, fixedly mounted on the tapering part 5 of the wrench head 2, on the opposite side to the position of the detent ball bearing 12. The guide pin 15 runs in a second guide groove 14, also of square cross section, on the inside of the cylindrical part 6. In a similar way to the first guide groove 13, the length of the second guide groove 14 corresponds to a turning of the wrench head 2 by one quarter turn. As in the case of the first guide groove 13, the pitch of the second guide groove 14, from the locked to the unlocked position, lies in the interval 10°-60°, corresponding to an axial tightening distance of the wrench head 2 of between 1-5 mm.

Said arrangement with two guide grooves, one on either side of the wrench head 2, serves to eliminate any imbalances that can occur when turning and locking the wrench head 2, which gives a very precise and distinct locking function.

In a special embodiment of the above, the upper part of the wrench head 2, comprising the adjustable ratchet mechanism, is detachably arranged on the wrench head 2 by way of a mechanical interlock coupling 8, which means that the upper part of the wrench head 2, which comprises the ratchet function 7 of the wrench 1 and the part that is connected to a fastener 16, can easily be exchanged.

In a special version, the mechanical interlock coupling 8 may also comprise a turning spindle for turning the lower, tapering part 5 perpendicularly upwards relative to the upper part of the wrench head 2 and relative to the fastener 16, according to FIG. 4. The extra turning spindle allows fasteners 16 to be turned in confined spaces 17 where a fastener is situated at a greater depth, according to FIG. 4.

The wrench 1 and its various parts are preferably made from some metal material, for example steel. Alternatively a fibre-reinforced plastic or a composite material may be used.

For a wrench of optimum ergonomic design, among other things the rear part of the handle is designed with an oval cross section that is easy to grip and is covered with a non-slip coating.

The invention is not limited to the embodiments shown but can be modified in various ways without departing from the scope of the patent claims. It will be realized, for example, that the number and size, material and shape of the constituent elements and parts of the wrench that are important for the invention can be adapted with respect to one another and with regard to how the wrench is used.

1. A wrench for turning a fastener, the wrench comprising:
a wrench head,
an intermediate part comprising a cylindrical part having a circular or oval cross section, and
an extension handle,
a spindle configured to rotatably arrange the cylindrical part on the extension handle,
a turning and locking mechanism configured to detachably arranged the wrench head on the intermediate part.

2. The wrench according to claim 1, wherein the wrench head comprises a tapering part having a circular or oval cross section designed to fit in the cylindrical part of the intermediate part.

3. The wrench according to claim 1, wherein the turning and locking mechanism comprises: a sprung detent ball bearing arranged on the tapering part of the wrench head; a hole corresponding to the detent ball bearing and arranged in the tubular part of the intermediate part for locking the detent ball bearing; a guide groove on the inside of the intermediate part for guiding the detent ball bearing when the wrench head is turned between the open and the locked position, the length of the guide groove corresponding to a turning of the wrench head by one quarter turn and the pitch of the guide groove corresponding to a tightening of the wrench head in an axial direction by 1-5 mm.

4. The wrench according to claim 1, wherein the turning and locking mechanism further comprises: a guide pin having a square cross section fixedly arranged on the tapering part opposite the detent ball bearing; a second guide groove of square cross section on the inside of the intermediate part opposite the first guide groove, for more precise guiding of the guide pin when turning the wrench head between the unlocked and the locked position.

5. The wrench according to claim 1, wherein the wrench head comprises an adjustable ratchet mechanism, adjustable for clockwise or counterclockwise turning of the fastener.

6. The wrench according to claim 1, further comprising:
a mechanical coupling configured to detachably arranged the upper part of the wrench head, comprising the ratchet mechanism, on the wrench head.

7. The wrench according to claim 6, wherein the mechanical coupling comprises a turning spindle for turning the upper part in a vertical direction relative to the upper part of the wrench head and relative to the fastener.
